(19) United States
(12) Patent Application Publication
(10) Pub. No.: US 2026/0296203 A1
(43) Pub. Date: Oct. 1, 2026

(54) PREVENTING THERMAL EVENTS IN VEHICLES

(71) Applicant: Rivian IP Holdings, LLC, Irvine, CA (US)

(72) Inventors: Armin TEYMOURI, San Pedro, CA (US); Younes SANGSEFIDI, Irvine, CA (US); Mehrdad YAZDANIAN, Irvine, CA (US); Chia-Chou YEH, Torrance, CA (US)

(21) Appl. No.: 19/096,465

(22) Filed: Mar. 31, 2025

(51) Int. Cl. B60L 3/00

(52) U.S. Cl. CPC B60L 3/003; B60L 2210/40; B60L 2240/16; B60L 2240/421; B60L 2240/525; B60L 2240/529; B60L 2250/16

(57) ABSTRACT

In one aspect, a method includes monitoring a first temperature of an electric motor of a vehicle during operation, and monitoring a second temperature of an inverter of an inverter system that drives the electric motor. The method further includes, responsive to detecting a fault of the inverter system: comparing a first current generated by the inverter with an expected current corresponding to a control signal used to drive the inverter; initiating a first fault action when the first current exceeds the expected current; and determining, based at least on the first temperature, the second temperature, and the comparison of the first current with the expected current, that a thermal event of the vehicle is imminent.

### INTRODUCTION

The present disclosure relates to techniques for identifying imminent thermal events in vehicles and intervening to prevent or reduce the impact of the thermal events.

In vehicle drive units, thermal events such as overheating can occur responsive to excessive current levels in the motor or inverter. Conventional approaches for identifying thermal hazards are based on detecting an overtemperature condition; however, these approaches tend to be unsuitably slow, identifying the hazards only after temperatures have reached elevated levels. Further, the fault actions that are used to address the hazards may be ineffective at mitigating the temperature excursion, and in some cases can even worsen the temperature excursion.

### SUMMARY

In one aspect, a method includes monitoring a first temperature of an electric motor of a vehicle during operation, and monitoring a second temperature of an inverter of an inverter system that drives the electric motor. The method further includes, responsive to detecting a fault of the inverter system: comparing a first current generated by the inverter with an expected current corresponding to a control signal used to drive the inverter; initiating a first fault action when the first current exceeds the expected current; and determining, based at least on the first temperature, the second temperature, and the comparison of the first current with the expected current, that a thermal event of the vehicle is imminent.

In another aspect, a computer program product includes one or more non-transitory computer-readable storage media, and program instructions stored on the one or more non-transitory computer-readable storage media that, when executed by one or more computer processors, cause the one or more computer processors to perform operations. The operations include monitoring a first temperature of an electric motor of a vehicle during operation, and monitoring a second temperature of an inverter of an inverter system that drives the electric motor. The operations further include, responsive to detecting a fault of the inverter system: comparing a first current generated by the inverter with an expected current corresponding to a control signal used to drive the inverter; initiating a first fault action when the first current exceeds the expected current; and determining, based at least on the first temperature, the second temperature, and the comparison of the first current with the expected current, that a thermal event of the vehicle is imminent.

In another aspect, a vehicle includes an electric motor, an inverter system configured to drive the electric motor, and one or more computer processors configured to perform operations. The operations include monitoring a first temperature of the electric motor during operation, and monitoring a second temperature of an inverter of the inverter system. The operations further include, responsive to detecting a fault of the inverter system: comparing a first current generated by the inverter with an expected current corresponding to a control signal used to drive the inverter; initiating a first fault action when the first current exceeds the expected current; and determining, based at least on the first temperature, the second temperature, and the comparison of the first current with the expected current, that a thermal event of the vehicle is imminent.

### BRIEF DESCRIPTION OF THE DRAWINGS

FIG. 1A illustrates an example vehicle in accordance with certain embodiments.

FIG. 1B illustrates a chassis of a vehicle in accordance with certain embodiments.

FIG. 2A is a schematic block diagram of components of a vehicle in accordance with certain embodiments.

FIG. 2B is a schematic block diagram of alternative components of a vehicle in accordance with certain embodiments.

FIG. 3 is a system diagram having an exemplary thermal hazard service in accordance with certain embodiments.

FIG. 4 is an exemplary method of operating a thermal hazard service in accordance with certain embodiments.

### DETAILED DESCRIPTION

In some embodiments, a method is described that includes monitoring a first temperature of an electric motor of a vehicle during operation, and monitoring a second temperature of an inverter of an inverter system that drives the electric motor. The method further includes, responsive to detecting a fault of the inverter system, comparing a first current generated by the inverter with an expected current corresponding to a control signal used to drive the inverter; initiating a first fault action for the inverter when the first current exceeds the expected current; and determining, based at least on the first temperature, the second temperature, and the comparison of the first current with the expected current, that a thermal event of the vehicle is imminent.

In this way, the approach provides robust, real-time monitoring for thermal hazards with rapid identification of conditions giving rise to imminent thermal events. The approach further supports vehicle-level fault actions, which allows earlier intervention for the temperature excursion. For example, in addition to any fault actions that are taken at the inverter level, some vehicle-level fault actions may include displaying a warning to the driver, actuating brakes to provide controlled deceleration and stopping of the vehicle, and so forth.

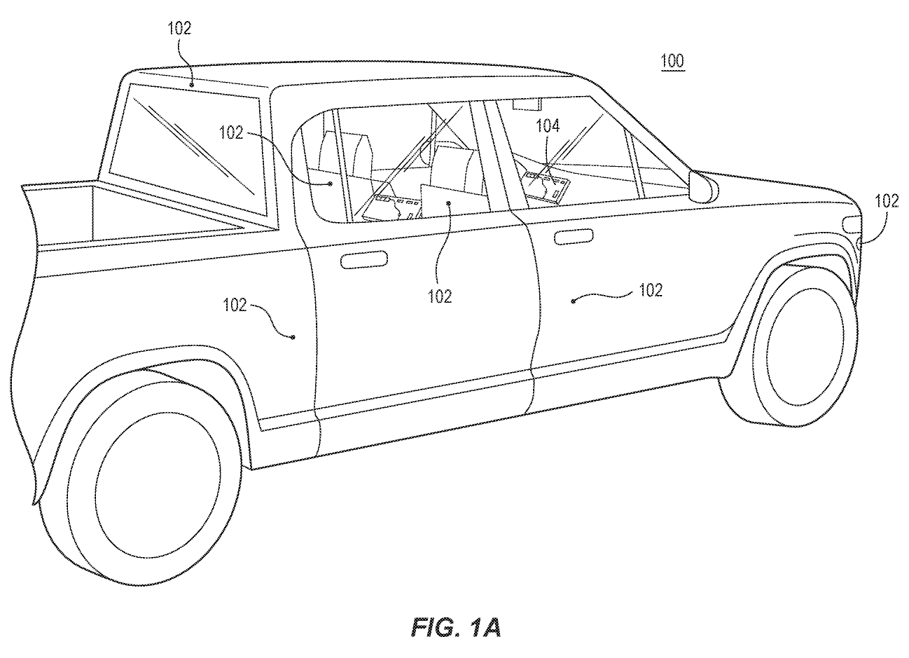

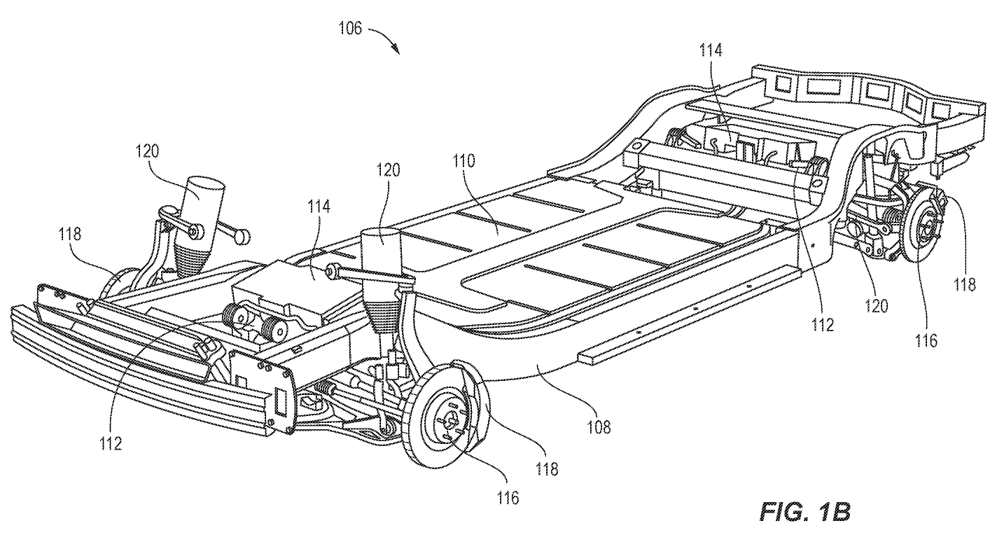

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery 110 may be substantially planar in shape.

Power from the battery 110 may be supplied to one or more drive units 112. Each drive unit 112 may be formed of an electric motor and possibly a gear reduction drive. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by an inverter system 114. The inverter system 114 may include inverters configured to convert direct current (DC) from the battery 110 into alternating current (AC) supplied to the motors of the drive units 112. In some embodiments, the inverter system 114 is implemented to include a plurality of power modules.

The drive units 112 are coupled to two or more hubs 116 to which wheels may mount. Each hub 116 includes a corresponding brake 118, such as the illustrated disc brakes. The drive units 112 or other component may also provide regenerative braking. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that requires heating in preparation for use, such as diesel engines.

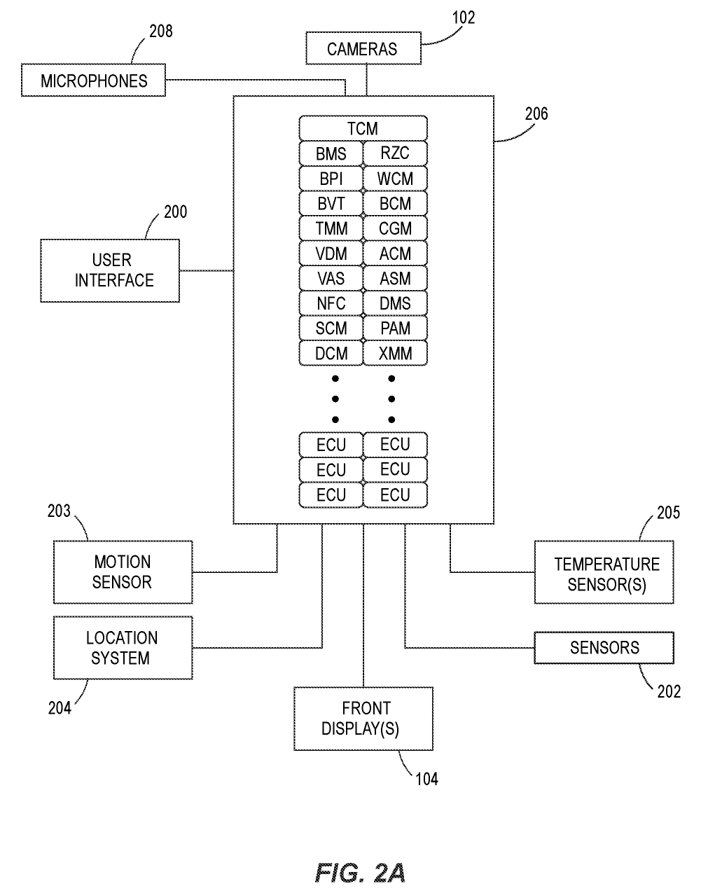

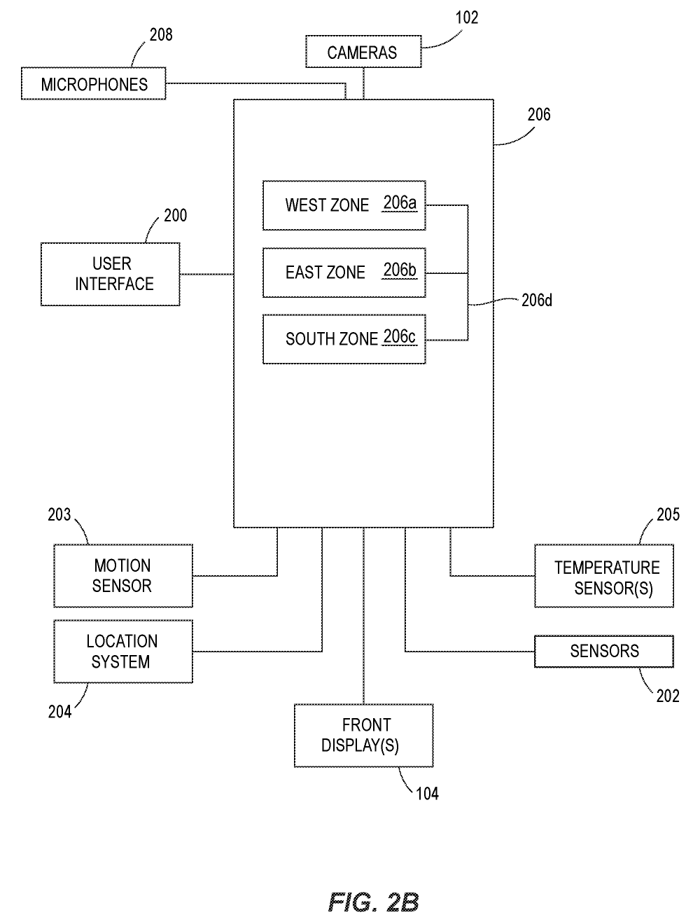

FIG. 2A illustrates example components of the vehicle 100 of FIG. 1A. As shown in FIG. 2A, the vehicle 100 includes the cameras 102, the one or more front displays 104, a user interface 200, one or more sensors 202, a motion sensor 203, and a location system 204. The one or more sensors 202 may include ultrasonic sensors, radio detection and ranging (RADAR) sensors, light detection and ranging (LIDAR) sensors, or other types of sensors. The location system 204 may be implemented as a global positioning system (GPS) receiver. The user interface 200 allows a user, such as a driver or passenger in the vehicle 100, to provide input.

The components of the vehicle 100 may include one or more temperature sensors 205. The temperature sensors 205 may include sensors configured to sense an ambient air temperature, temperature of the battery 110, temperature of the inverter system 114, temperature of each drive unit 112 and/or each motor of each drive unit 112, or the temperature of any other component of the vehicle 100.

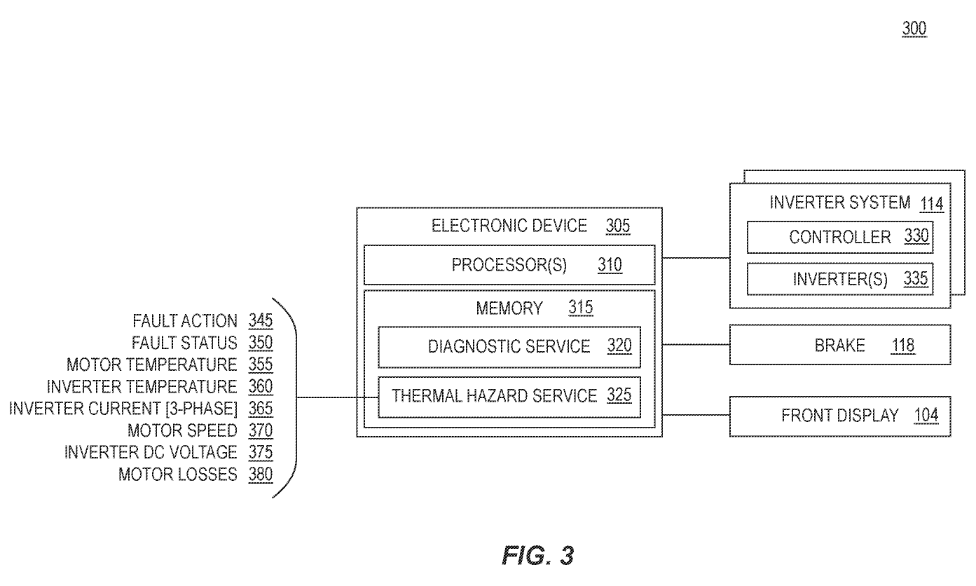

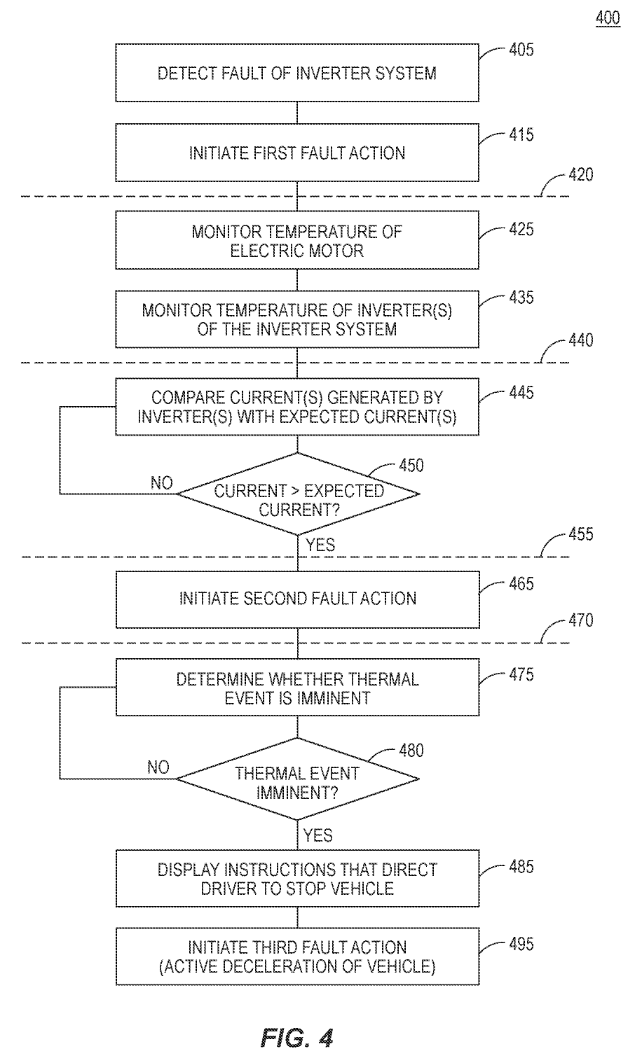

A control system 206 executes instructions to perform at least some of the actions or functions of the vehicle 100, including the functions described in relation to FIGS. 3 and 4. For example, as shown in FIG. 2A, the control system 206 may include one or more electronic control units (ECUs) configured to perform at least some of the actions or functions of the vehicle 100, including the functions described in relation to FIGS. 3 and 4. In certain embodiments, each of the ECUs is dedicated to a specific set of functions. Each ECU may be implemented as a computer system and may include functionality described below in relation to FIGS. 3 and 4.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle’s communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102 and sensors 202.

The control system 206 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 208, etc.) to the TCM ECU.

Referring to FIG. 2B, in some embodiments, the control system 206 may be implemented as a plurality of zonal controllers 206a, 206b, 206c. Each zonal controller 206a, 206b, 206c may control a subset of systems of the vehicle. The subset of systems controlled by each zonal controller 206a, 206b, 206c may be generally assigned based on location within the vehicle 100. For example, a west zonal controller 206a may control systems on a driver side of the vehicle 100, an east zonal controller 206b may control systems on a passenger side of the vehicle 100, and a south zonal controller 206c may control systems in a rear portion of the vehicle. Each zonal controller 206a, 206b, 206c may implement a portion of the functions ascribed to the ECUs of the control system 206 of FIG. 2A. The functions of the ECUs may be distributed among the zonal controller 206a, 206b, 206c such that only one zonal controller 206a, 206b, 206c implements the functions of each ECU. Alternatively, the functions of an ECU may be duplicated across multiple zonal controllers 206a, 206b, 206c, each zonal performing the functions of the ECU for the portion of the vehicle to which that zonal controller 206a, 206b, 206c is assigned.

The zonal controllers 206a, 206b, 206c may be connected to one another by a network 206d, such as an Ethernet network, controller area network (CAN), or other type of network.

Refer now to diagram 300 of FIG. 3, in which an electronic device 305 is operatively connected with the one or more inverter systems 114 of the vehicle 100, the brake 118, and the front display 104. As used herein, an “electronic device” generally refers to any device having electronic circuitry that provides a processing or computing capability, and that implements logic and/or executes program code to perform various operations that collectively define the functionality of the electronic device 305. The functionality of the electronic device 305 includes a communicative capability with one or more other electronic devices, e.g., when connected to a same network. The electronic device 305 may be implemented with any suitable form factor, whether relatively static in nature (e.g., mainframe, computer terminal, server, kiosk, workstation) or mobile (e.g., laptop computer, tablet, handheld, smart phone, wearable device). The communicative capability between electronic devices may be achieved using any suitable techniques, such as conductive cabling, wireless transmission, optical transmission, and so forth.

The electronic device 305 comprises one or more processors 310 and a memory 315. The one or more processors 310 are any electronic circuitry, including, but not limited to one or a combination of microprocessors, microcontrollers, application-specific integrated circuits (ASIC), application-specific instruction set processors (ASIP), and/or state machines, that is communicatively coupled to the memory 315 and controls the operation of the system. In some aspects, the electronic circuitry is configured to perform any of the functions described herein. Further, the one or more processors 310 are not limited to a single processing device and may encompass multiple processing devices.

The one or more processors 310 may include other hardware that operates software to control and process information. In some aspects, the one or more processors 310 execute software stored in the memory 315 to perform any of the functions described herein. The one or more processors 310 control the operation and administration of the electronic device 305 by processing information (e.g., information received from input devices and/or communicatively coupled electronic devices).

The memory 315 may store, either permanently or temporarily, data, operational software, or other information for the one or more processors. The memory 315 may include any one or a combination of volatile or non-volatile local or remote devices suitable for storing information. For example, the memory may include random-access memory (RAM), read-only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory, a disk, a CD, or a flash drive. In particular embodiments, the software may include an application executable by the one or more processors 310 to perform one or more of the functions described herein. For example, the memory 315 includes a diagnostic service 320 and a thermal hazard service 325, each of which may represent an application and/or other code. In some implementations, the electronic device 305 encompasses some or all of the control system 206 of FIGS. 2A, 2B (e.g., one or more of the ECUs).

Referring also to FIG. 1, the inverter system 114 includes a plurality of components configured to convert direct current (DC) power from the battery 110 into alternating current (AC) power, such as three-phase AC, that is supplied to one or more motors of the drive unit(s) 112 corresponding to the inverter system 114.

In some embodiments, the inverter system 114 receives power from the battery 110 through a DC link capacitor connected between the positive and negative terminals of the battery 110, and functions to smooth current received from the battery 110 as part of the process by which the DC power from the battery 110 is converted to an approximately sinusoidal AC waveform. The DC link capacitor may further function to dampen any voltage spikes. Further, the DC link capacitor may provide smoothed DC power to a single inverter system 114 or may be shared by multiple inverter systems 114. Although not shown, other filtering circuitry at the DC link is also contemplated.

In some embodiments, the inverter system 114 includes one or more power inverters 335 (also referred to as inverter(s) 335) that are connected to the battery 110 through the DC link capacitor. In some embodiments, the one or more power inverters 335 comprise a plurality of power inverters that each provide an AC waveform having a different phase, e.g., three (3) power inverters that collectively provide three-phase AC power. The power inverter(s) 335 include a plurality of switches, such as insulated gate bipolar transistors (IGBTs), that are selectively opened and closed to cause transmission of current to the outputs of the inverter system 114 with desired AC electrical characteristics (e.g., waveform, voltage, current, frequency, phase, and so forth) for driving the motor(s). For example, the power inverter(s) 335 may output three-phase current over transmission lines to the motor(s). Although not shown, filtering circuitry may be included between the power inverter(s) 335 and the transmission lines.

The opening and closing of the power inverter(s) 335 is controlled by a controller 330 comprising control circuitry. In some embodiments, the control circuitry is included in a printed circuit board assembly (PCBA) and comprises various electronic components that generate the control signals for the power inverter(s) 335. In some embodiments, the inverter system 114 drives two (2) drive units 112 and includes separate PCBAs for supplying current to the motors of the separate drive units 112. In other embodiments, the inverter system 114 drives a single drive unit 112.

In some embodiments, the controller 330 includes a microprocessor programmed to control operation of the controller 330 and the power inverter(s) 335. The microprocessor may be embodied as a silicon chip mounted to the PCBA of the controller 330. In some embodiments, a temperature sensor provides temperature measurements to the controller 330, which controls the operation of the power inverter(s) 335 based in part on the temperature measurements. In some embodiments, the temperature sensor is operatively connected to a busbar that is connected to the DC link capacitor, and the temperature measurements may be used by the controller 330 to derate the output from the plurality of power inverter(s) 335 from a nominal output.

The controller 330 is connected to the electronic device 305, and in some embodiments implements instructions from the electronic device 305 (e.g., provided by the diagnostic service 320 and/or the thermal hazard service 325) to control current supplied to the motor(s) and/or to cause the motor(s) to produce regenerative current. The electronic device 305 may generate such instructions according to an automated driving algorithm (e.g., automatic cruise control), a safety algorithm (e.g., traction control, stability control, automated emergency braking), and/or in response to inputs from a driver by way of an accelerator pedal and/or brake pedal.

The diagnostic service 320 identifies fault conditions occurring in one or more systems of the vehicle 100. In some embodiments, the diagnostic service 320 identifies fault conditions occurring in the inverter system 114. Some non-limiting examples of fault conditions of the inverter system 114 include overheating (e.g., caused by excessive load or inadequate cooling), damage or failures occurring in the switches or other components, faulty sensors, communication errors with the electronic device 305, damaged wiring, low battery voltage, and problems with input voltage regulation. In some embodiments, some or all of the fault conditions in the inverter system 114 may be first identified by the controller 330 of the inverter system 114, and communicated to the diagnostic service 320.

The diagnostic service 320 receives a first set of one or more inputs, and applies the inputs to an algorithm or to a model to identify whether any fault conditions are present. In some embodiments, the inputs may include sensor inputs (e.g., measurements of temperature, speed, voltage, current), control inputs (e.g., algorithmic instructions provided by the electronic device 305 to the controller 330, driver-provided inputs), environmental inputs, and so forth.

In some embodiments, the electronic device 305 and/or the controller 330 changes operation of the power inverter(s) 335 responsive to a fault condition identified by the diagnostic service 320. In one example, the controller 330 may automatically initiate a fault action responsive to the fault condition, where the fault action includes operating the power inverter(s) 335 more conservatively (e.g., reducing a voltage or current output by the power inverter(s) 335). In another example, the electronic device 305 may alter the instructions provided to the controller 330, operating the inverter system 114 according to a more conservative algorithm to safely operate the vehicle 100 following the fault condition.

Certain fault conditions can cause currents in the motor and/or in the power inverter(s) 335 to increase beyond nominal values, which in turn causes increased temperatures. For example, a damaged power module or a short circuit in the motor winding can cause large and uncontrolled current flows. In some cases, the current flow can be proportional to vehicle speed, e.g., due to the back electromotive force (EMF) phenomenon of interior permanent magnet (IPM) motors. Thus, any fault action(s) directed to the operation of the motor and/or the power inverter(s) 335 may not be effective to prevent a thermal event, as current continues to flow while the vehicle 100 is still moving.

The thermal hazard service 325 receives a second set of one or more inputs, and applies the inputs to an algorithm or to a model to identify whether any thermal events have occurred or are imminent. The second set may fully or partially overlap with the first set, and may include sensor inputs, control inputs, and/or environmental inputs, and so forth. In some embodiments, the second set includes at least a first temperature of a motor, a second temperature of a power inverter 335 of the inverter system 114 that drives the motor, and a current generated by the power inverter 335. In some embodiments, the second set further includes fault information provided by the diagnostic service 320. As shown, the second set of one or more inputs comprises a fault action 345 taken by the controller 330 or by the electronic device 305, a fault status 350 provided by the diagnostic service 320, a motor temperature 355, an inverter temperature 360, an inverter current 365 (which in some cases may be a three-phase current), a motor speed 370, an inverter DC voltage 375, and motor losses 380 (e.g., energy losses occurring in various components such as the stator, rotor, and windings). Other inputs are also contemplated, such as a motor torque, a coolant flow, a coolant temperature, a stator temperature, a rotor temperature, and so forth.

In some embodiments, the thermal hazard service 325 uses values of the one or more inputs of the second set to estimate an amount of time until a thermal event occurs. Some non-limiting examples of thermal events include degraded operation of one or more components of the vehicle 100, damage to the one or more components, and fire. In some embodiments, the thermal hazard service 325 stores an object that includes a plurality of records, and each record includes a plurality of fields. The plurality of fields may include one or more fields that correspond to the one or more inputs of the second set, and one or more fields that correspond to an estimated time to a thermal event. The estimated time may be represented in any suitable form, such as an estimated amount of time (e.g., seconds, minutes, other operational units) until a thermal event, an absolute time value, and so forth. The plurality of fields may further include one or more fields describing the expected thermal event, such as a type, a duration, a severity, and so forth. Thus, the various records of the object may represent estimated amounts of time to a thermal event for different combinations of values of the one or more inputs of the second set.

Continuing the object-based example, the thermal hazard service 325 compares the values of the one or more inputs of the second set with one or more records of the object to estimate the time until the thermal event. In one example, the thermal hazard service 325 may identify a record that is nearest to the values of the one or more inputs, and use the estimated time of the record. In another example, the thermal hazard service 325 may identify the nearest records and interpolate the corresponding values of estimated time.

In some embodiments, the thermal hazard service 325 determines that a thermal event is imminent when the estimated amount of time to the thermal event is less than a threshold value. The threshold value may be selected to allow one or more fault actions (e.g., a sequence of multiple fault actions) to be performed by the electronic device 305 and/or the controller 330 to prevent or delay a thermal event, to allow the driver to safely stop and exit the vehicle, and so forth. For example, the threshold value may be one (1) minute or less, such as 40 seconds, 30 seconds, 20 seconds, 15 seconds, 10 seconds, and so forth.

The thermal hazard service 325 may operate continuously or intermittently. In some embodiments, the thermal hazard service 325 operates responsive to detecting a particular fault or fault action. For example, the diagnostic service 320 may detect a desaturation condition of a switch of a power inverter 335, and signal the electronic device 305 to begin operation of the thermal hazard service 325. A desaturation condition generally occurs when a maximum rated current of the switch is exceeded, causing a rise in the collector-emitter voltage of the switch, and can be indicative of a hardware failure (or imminent failure) within the power inverter 335.

In some embodiments, the controller 330 may take an inverter-level fault action responsive to the desaturation condition, which can be overlapping in time with initiating the thermal hazard service 325. Some non-limiting examples of an inverter-level fault action include controlling the (desaturated) switch of the power inverter 335 into an open-circuit configuration, operating a low-side switch or a high-side switch of the power inverter 335 according to the motor speed 370, shorting a low-side switch or a high-side switch of the power inverter 335, and so forth.

During operation, the thermal hazard service 325 monitors real-time measurements of the inverter current 365 (e.g., three-phase currents), the motor temperature 355, and the inverter temperature 360. In some embodiments, the thermal hazard service 325 compares a measured current generated by the power inverter 335 (e.g., a phase current) with an expected current corresponding to a control signal used to drive the power inverter 335. The comparison may be intermittent or performed substantially continuously (e.g., comparing each sample of the current with the expected current). In some embodiments, when the measured current exceeds the expected current by a threshold amount, this indicates to the thermal hazard service 325 that a thermal event is imminent. In some embodiments, responsive to determining that the thermal event is imminent, the electronic device 305 displays (e.g., using the front display 104) instructions that direct a driver of the vehicle 100 to stop the vehicle 100. In some embodiments, the electronic device 305 further initiates a vehicle-level fault action comprising active deceleration of the vehicle 100. The active deceleration may include operating the brake 118 after, or in combination with, displaying the instructions to the driver. In one example, the electronic device 305 operates the brake 118 after determining that the driver has not slowed or stopped the vehicle 100 after displaying the instructions, such that the thermal event continues to be imminent. In another example, the electronic device 305 operates the brake 118 along with displaying the instructions, although the application of the brake 118 may be gradual.

In this way, the electronic device 305 can provide real-time identification of conditions giving rise to imminent thermal events. Beyond the inverter-level fault actions taken by the controller 330 and/or the electronic device 305, the electronic device 305 also provides vehicle-level fault actions such as notification of the driver and active deceleration, which allows earlier intervention for the temperature excursion and decreases the likelihood of a thermal event of the vehicle 100.

FIG. 4 is an exemplary method 400 of operating the thermal hazard service 325 in accordance with certain embodiments. The method 400 may be used in conjunction with other embodiments, e.g., performed by the electronic device 305 in conjunction with the diagnostic service 320.

The method 400 begins at block 405, where the diagnostic service 320 detects a fault of the inverter system 114. At block 415, the electronic device 305 (or the controller 330) initiates a first fault action for a power inverter 335 of the inverter system 114. In some embodiments, the fault of the inverter system 114 is a desaturation condition of a switch of a power inverter 335.

In some embodiments, a first predetermined interval 420 elapses between block 415 and block 425. The first predetermined interval 420 may be selected to allow the first fault action to be performed, as well as to allow the electronic device 305 to analyze the response of the inverter system 114 to the first fault action. For example, the first predetermined interval 420 may be between about 50 milliseconds (ms) and 150 ms.

At block 425, the thermal hazard service 325 monitors a temperature of an electric motor of the drive unit associated with the inverter system 114. At block 435, the thermal hazard service 325 monitors a temperature of one or more inverters 335 of the inverter system 114. In some embodiments, blocks 425, 435 begin at substantially the same time following the predetermined interval 420. In some embodiments, the thermal hazard service 325 (or the electronic device 305) starts one or more counters following the predetermined interval 420, such as a first counter for re-analyzing whether another fault action should be initiated, and a second counter for displaying instructions to the driver.

In some embodiments, a second predetermined interval 440 elapses between block 435 and block 445, and may correspond to the first counter. For example, the second predetermined interval 440 may be less than two seconds, such as between about 500 ms and 1.5 s.

At block 445, the thermal hazard service 325 compares the current(s) generated by the inverter(s) 335 with expected current(s) corresponding to control signal(s) used to drive the inverter(s) 335. For example, the thermal hazard service 325 may compare each phase current with the corresponding expected current. If, at block 450, the current is not greater than the expected current (“NO”), flow returns to block 445 and the thermal hazard service 325 compares a next sample of the current(s) with the expected current(s).

If, however, the current is greater than the expected current (“YES”), flow proceeds to block 465. In some embodiments, a third predetermined interval 455 elapses between block 450 and block 465, which may correspond in length to the first predetermined interval 420 (e.g., shorter than the second predetermined interval 440, and in some cases between about 50 ms and 150 ms).

At block 465, the thermal hazard service 325 or the electronic device 305 initiates a second fault action. In some embodiments, the second fault action may be the same as the first fault action. In other embodiments, the second fault action differs from the first fault action. For example, the second fault action may be less drastic than the first fault action, as the second fault action may better correspond to the condition of the inverter system 114. The thermal hazard service 325 may continue to monitor the temperature(s) and the current, and optionally any other parameters that may be used to determine whether a thermal event is imminent.

In some embodiments, a fourth predetermined interval 470 elapses between block 465 and block 475, which may correspond in length to the second predetermined interval 440 (e.g., in some cases between about 500 ms and 1.5 s).

At block 475, the thermal hazard service 325 determines whether a thermal event is imminent. In some embodiments, determining whether the thermal event is imminent is based at least on the motor temperature 355, the inverter temperature 360, and the comparison of the inverter current 365 with the expected current. In some cases, the value of the expected current differs from that of block 450 as the baseline operation of the inverter is different due to the earlier fault action(s). For example, the value of the expected current may be greater than the expected current during normal operation (e.g., driving the switches according to pulse-width modulation (PWM)). In some embodiments, determining whether the thermal event is imminent is further based on one or more of: the fault action 345, the fault status 350, the motor speed 370, the inverter DC voltage 375, and the motor losses 380.

In some embodiments, determining whether the thermal event is imminent may be performed by applying the various inputs to a model or to an algorithm (which in some cases may be object-based) to estimate the time until the thermal event. The estimated time may be compared with a threshold value, and the thermal event is deemed to be imminent when the estimated amount of time to the thermal event is less than the threshold value.

If, at block 480, the thermal event is not imminent (“NO”), flow returns to block 475 and the thermal hazard service 325 applies the next sample of the inputs and estimates the time until the thermal event. If the thermal event is imminent (“YES”), flow proceeds to block 485, where the electronic device 305 displays (e.g., using a front display 104 of the vehicle 100) instructions that direct the driver to stop the vehicle 100. At block 495, the electronic device 305 initiates a third fault action comprising active deceleration of the vehicle 100. In some embodiments, the active deceleration may include operating the brake 118 after, or in combination with, displaying the instructions to the driver. In one example, the electronic device 305 operates the brake 118 after determining that the driver has not slowed or stopped the vehicle 100 after displaying the instructions, such that the thermal event continues to be imminent. In another example, the electronic device 305 operates the brake 118 along with displaying the instructions, although the application of the brake 118 may be gradual.

The method 400 ends following completion of block 495. Thus, the electronic device 305 is capable of addressing a fault occurring in the inverter system 114 at the inverter level and, if needed, at the vehicle level to decrease the likelihood of a thermal event. In some embodiments, the entire fault response may occur in less than five (5) seconds, such as two (2) seconds or less, which substantially decreases the likelihood of the thermal event.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. A method comprising:
monitoring a first temperature of an electric motor of a vehicle during operation;
monitoring a second temperature of an inverter of an inverter system that drives the electric motor; and
responsive to detecting a fault of the inverter system:
comparing a first current generated by the inverter with an expected current corresponding to a control signal used to drive the inverter;
initiating a first fault action when the first current exceeds the expected current; and
determining, based at least on the first temperature, the second temperature, and the comparison of the first current with the expected current, that a thermal event of the vehicle is imminent.

2. The method of claim 1, wherein the fault is a desaturation condition of a switch of the inverter.

3. The method of claim 1, further comprising:
initiating, prior to the first fault action, a second fault action for the inverter responsive to detecting the fault of the inverter system,
wherein the monitoring of the first temperature and the monitoring of the second temperature are responsive to detecting the fault of the inverter system.

4. The method of claim 1, further comprising:
displaying, responsive to determining that the thermal event is imminent, instructions that direct a driver of the vehicle to stop the vehicle.

5. The method of claim 1, wherein determining whether a thermal event of the vehicle is imminent comprises:
comparing, responsive to a predetermined interval elapsing after initiating the first fault action, a second current generated by the inverter with a second expected current, wherein the thermal event is deemed imminent when the second current exceeds the second expected current,
the method further comprising:
initiating a third fault action when the second current exceeds the second expected current, the third fault action comprising active deceleration of the vehicle.

6. The method of claim 5, wherein the predetermined interval is less than one second.

7. The method of claim 1, wherein determining whether a thermal event of the vehicle is imminent is further based on one or more of the following:
the first fault action;
a fault status of the inverter system;
a speed of the electric motor;
a direct current (DC) voltage of the inverter system; and
energy loss of the electric motor.

8. A computer program product comprising:
one or more non-transitory computer-readable storage media; and
program instructions stored on the one or more non-transitory computer-readable storage media that, when executed by one or more computer processors, cause the one or more computer processors to perform operations comprising:
monitoring a first temperature of an electric motor of a vehicle during operation;
monitoring a second temperature of an inverter of an inverter system that drives the electric motor; and
responsive to detecting a fault of the inverter system:
comparing a first current generated by the inverter with an expected current corresponding to a control signal used to drive the inverter;
initiating a first fault action when the first current exceeds the expected current; and
determining, based at least on the first temperature, the second temperature, and the comparison of the first current with the expected current, that a thermal event of the vehicle is imminent.

9. The computer program product of claim 8, wherein the fault is a desaturation condition of a switch of the inverter.

10. The computer program product of claim 8, the operations further comprising:
initiating, prior to the first fault action, a second fault action for the inverter responsive to detecting the fault of the inverter system,
wherein the monitoring of the first temperature and the monitoring of the second temperature are responsive to detecting the fault of the inverter system.

11. The computer program product of claim 8, the operations further comprising:
displaying, responsive to determining that the thermal event is imminent, instructions that direct a driver of the vehicle to stop the vehicle.

12. The computer program product of claim 8, wherein determining whether a thermal event of the vehicle is imminent comprises:
comparing, responsive to a predetermined interval elapsing after initiating the first fault action, a second current generated by the inverter with a second expected current, wherein the thermal event is deemed imminent when the second current exceeds the second expected current,
the operations further comprising:
initiating a third fault action when the second current exceeds the second expected current, the third fault action comprising active deceleration of the vehicle.

13. The computer program product of claim 12, wherein the predetermined interval is less than one second.

14. The computer program product of claim 8, wherein determining whether a thermal event of the vehicle is imminent is further based on one or more of the following:
the first fault action;
a fault status of the inverter system;
a speed of the electric motor;
a direct current (DC) voltage of the inverter system; and
energy loss of the electric motor.

15. A vehicle comprising:
an electric motor;
an inverter system configured to drive the electric motor; and
one or more computer processors configured to perform operations comprising:
monitoring a first temperature of the electric motor during operation;
monitoring a second temperature of an inverter of the inverter system; and
responsive to detecting a fault of the inverter system:
comparing a first current generated by the inverter with an expected current corresponding to a control signal used to drive the inverter;
initiating a first fault action when the first current exceeds the expected current; and
determining, based at least on the first temperature, the second temperature, and the comparison of the first current with the expected current, that a thermal event of the vehicle is imminent.

16. The vehicle of claim 15, wherein the fault is a desaturation condition of a switch of the inverter.

17. The vehicle of claim 15, the operations further comprising:
initiating, prior to the first fault action, a second fault action for the inverter responsive to detecting the fault of the inverter system,
wherein the monitoring of the first temperature and the monitoring of the second temperature are responsive to detecting the fault of the inverter system.

18. The vehicle of claim 15, the operations further comprising:
displaying, responsive to determining that the thermal event is imminent, instructions that direct a driver of the vehicle to stop the vehicle.

19. The vehicle of claim 15, wherein determining whether a thermal event of the vehicle is imminent comprises:
comparing, responsive to a predetermined interval elapsing after initiating the first fault action, a second current generated by the inverter with a second expected current, wherein the thermal event is deemed imminent when the second current exceeds the second expected current,
the operations further comprising:
initiating a third fault action when the second current exceeds the second expected current, the third fault action comprising active deceleration of the vehicle.

20. The vehicle of claim 15, wherein determining whether a thermal event of the vehicle is imminent is further based on one or more of the following:
the first fault action;
a fault status of the inverter system;
a speed of the electric motor;
a direct current (DC) voltage of the inverter system; and
energy loss of the electric motor.
